(19) United States
(12) Patent Application Publication
(10) Pub. No.: US 2024/0417008 A1
(43) Pub. Date: Dec. 19, 2024

(54) DEPLOYABLE AERODYNAMIC ELEMENT FOR A VEHICLE

(71) Applicant: Honda Motor Co., Ltd., Tokyo (JP)

(72) Inventor: Pirooz MORADNIA, Dublin, OH (US)

(21) Appl. No.: 18/333,844

(22) Filed: Jun. 13, 2023

(51) Int. Cl. B62D 37/02; B62D 35/00

(52) U.S. Cl. CPC B62D 37/02; B62D 35/001; B62D 35/007

(57) ABSTRACT

A deployable aerodynamic element for a vehicle including a deformable frame forming at least a portion of a periphery of the aerodynamic element and sheeting configured to extend between the frame and a body of the vehicle. The aerodynamic element may be deployable between a stowed position in which the frame of the aerodynamic element has a first shape and a deployed position in which the sheeting of the aerodynamic element has a second shape that is different than the first shape.

### TECHNICAL FIELD

The present disclosure generally relates to an aerodynamic element for a vehicle and, more particularly, a deployable aerodynamic element with a deformable frame.

### BACKGROUND

The desirable configuration for an automotive aerodynamic element may differ depending on various conditions, such as vehicle operating conditions (e.g., vehicle speed, acceleration, yaw rate, etc.), geographic location, ambient temperature, precipitation, etc. Since most vehicles operate in a variety of conditions, it is desirable for aerodynamic elements to have variable configurations. For example, it may be desirable for an aerodynamic element to have a different shape under certain conditions, such as at higher speeds.

The present disclosure is directed at implementing one or more of the desirable features and/or functions described above.

### SUMMARY

An exemplary aerodynamic element for a vehicle may utilize deformable frame that changes shape with movement with respect to the body of the vehicle. For example, one or more portions of sheeting may be attached to the body of the vehicle and other portion(s) of the sheeting may be attached to the movable, deformable frame. As the frame is moved away from the body of the vehicle, the at least one structural member of the frame may deform to provide the aerodynamic element with a different shape. In some embodiments, the different shape may provide the aerodynamic element with a different aerodynamic effect under different conditions. In other embodiments, the different aerodynamic shape may enable the aerodynamic element to maintain the same or similar aerodynamic effect as conditions change. For example, as vehicle speed increases, the aerodynamic effect of the aerodynamic element may be maintained by changing the trailing edge of the aerodynamic element from substantially straight to curved.

In one aspect, the present invention is directed to a deployable aerodynamic element for a vehicle including a deformable frame forming at least a portion of a periphery of the aerodynamic element and sheeting configured to extend between the frame and a body of the vehicle. The aerodynamic element may be deployable between a stowed position in which the frame of the aerodynamic element has a first shape and a deployed position in which the sheeting of the aerodynamic element has a second shape that is different than the first shape.

In another aspect, the present invention is directed to an adaptive vehicle aerodynamics system including a deployable aerodynamic element, including: a deformable frame forming at least a portion of a periphery of the aerodynamic element and sheeting configured to extend between the frame and a body of the vehicle. The frame may be movable with respect to the body of the vehicle such that the aerodynamic element is deployable between a stowed position in which the frame of the aerodynamic element has a first shape and a deployed position in which the frame of the aerodynamic element has a second shape that is different than the first shape. In addition, the system may include a controller including a device processor and a non-transitory computer readable medium including instructions executable by the processor to control operation of the deployable aerodynamic element.

In another aspect, the present invention is directed to a vehicle having an adaptive aerodynamic element including a vehicle body and a deployable aerodynamic element mounted on the vehicle, the deployable aerodynamic element including: a deformable frame forming at least a portion of a periphery of the aerodynamic element and sheeting configured to extend between the frame and the vehicle body. The frame may be movable with respect to the vehicle body such that the aerodynamic element is deployable between a stowed position in which the frame of the aerodynamic element has a first shape and a deployed position in which the frame of the aerodynamic element has a second shape that is different than the first shape.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic perspective view of a rear of a vehicle with an aerodynamic element in a stowed position according to an exemplary embodiment;

FIG. 2 shows the vehicle of FIG. 1 with the aerodynamic element in a deployed position;

FIG. 3 is a schematic partial side view of a vehicle with an aerodynamic element in a stowed position according to an exemplary embodiment;

FIG. 4 shows the vehicle of FIG. 3 with the aerodynamic element in a deployed position;

FIG. 5 is a schematic partial top view of a vehicle with an aerodynamic element in a stowed position according to an exemplary embodiment;

FIG. 6 shows the vehicle of FIG. 5 with the aerodynamic element in a deployed position;

FIG. 7 is a schematic partial rear view of a vehicle with an aerodynamic element in a stowed position with a frame of the aerodynamic element illustrated;

FIG. 8 shows the vehicle of FIG. 7 with the aerodynamic element in a deployed position;

FIG. 9 is a schematic block diagram illustrating components of an adaptive aerodynamic system; and

FIG. 10 is a flow chart illustrating steps of a method of operating the system illustrated in FIG. 9.

### DETAILED DESCRIPTION

The disclosed invention relates generally to a deployable aerodynamic element for a vehicle. As such, the invention can be used in connection with any type of vehicle. Thus, the terms “automobile” and “vehicle” as used throughout the specification and claims refer to any moving vehicle. For example, it will be understood that the term “vehicle,” as used herein, refers to cars, trucks, vans, minivans, sport utility vehicles (SUV's), watercraft, aircraft, and other such vehicles. It will be further understood that, when referring to a “vehicle,” the present disclosure also encompasses trailers that may be pulled by a powered vehicle. That is, the disclosed aerodynamic elements may be disposed on the body of a trailer.

As used herein, the term “fixedly attached” shall refer to two components joined in a manner such that the components may not be readily separated (for example, without destroying one or both components).

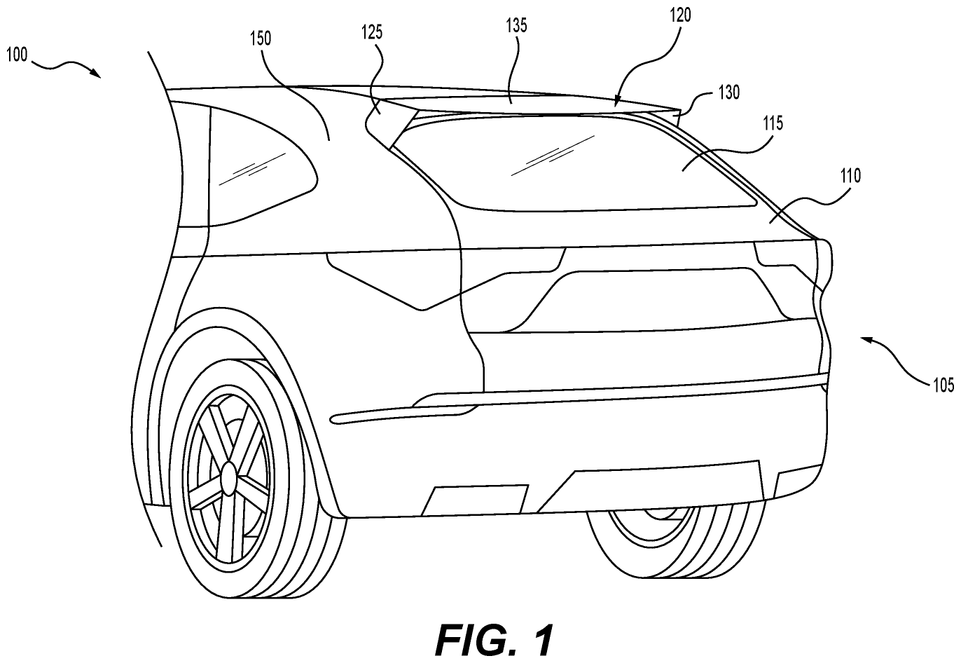

An exemplary aerodynamic element for a vehicle is discussed below. As illustrated in the accompanying figures, the aerodynamic element may utilize a deformable frame that changes shape with movement of the frame. In some embodiments, such an aerodynamic element may be implemented as a roof spoiler. FIGS. 1-8 illustrate an exemplary roof spoiler type aerodynamic element including a deformable frame.

A deployable aerodynamic element for a vehicle may include a deformable frame forming at least a portion of a periphery of the aerodynamic element and sheeting configured to extend between the frame and a body of the vehicle. The aerodynamic element is deployable between a stowed position in which the frame of the aerodynamic element has a first shape and a deployed position in which the sheeting of the aerodynamic element has a second shape that is different than the first shape.

FIG. 1 is a schematic perspective view of a rear of a vehicle with an aerodynamic element in a stowed position according to an exemplary embodiment. As shown in FIG. 1, a vehicle 100 has a rear portion 105 including a rear hatch 110, which incorporates a rear window. As further shown in FIG. 1, vehicle 100 includes, at the top portion of rear hatch 110, an aerodynamic element 120. In the illustrated embodiment, aerodynamic element 120 is shown as a roof spoiler. Such roof spoilers, depending on their configuration, may be utilized to reduce drag, produce downforce, and/or to direct air down along the rear window to keep it clean.

It will be understood that, in other embodiments, the aerodynamic element may be implemented in other portions of the vehicle. As for example, aerodynamic elements formed with a deformable frame may be used in other portions of a vehicle besides a roof spoiler. For example, such aerodynamic elements may be implemented as a front air dam, decklid spoiler, wheel strakes, air dam, sunroof deflector, side window visor, underbody covering, hood deflector, etc.

FIG. 1 shows aerodynamic element 120 in a stowed position. As shown in FIG. 1, aerodynamic element 120 has a stowed shape. For example, a first side portion 125 and a second side portion 130 may have a first trapezoidal shape, and a center portion 135 may have a first substantially hemispherical shape.

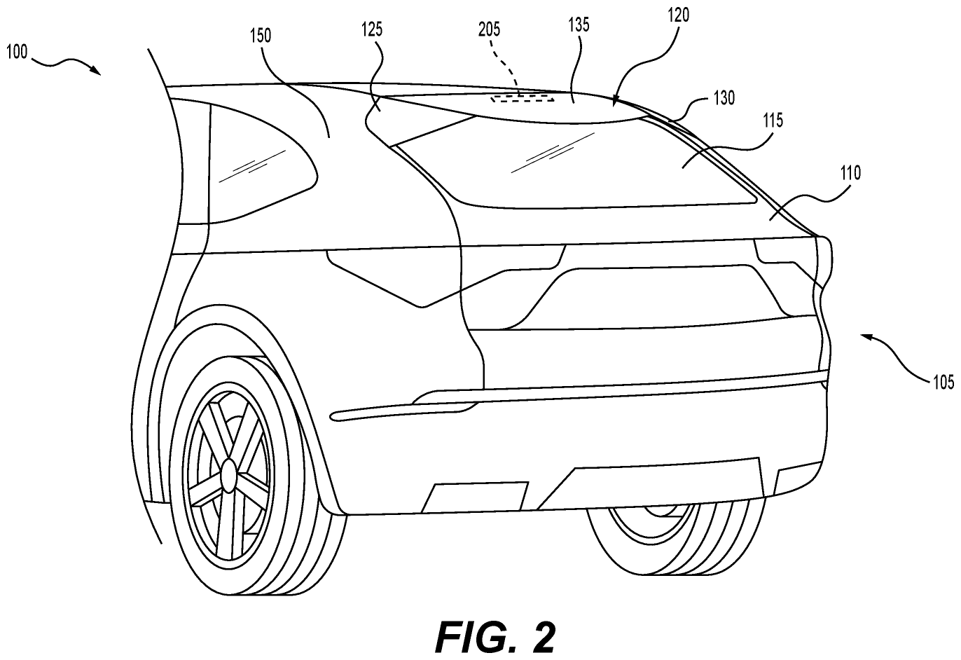

The disclosed aerodynamic element 120 may include a frame forming at least a portion of a periphery of the aerodynamic element and sheeting configured to extend between the frame of the aerodynamic element and the body of the vehicle. The frame may be movable with respect to the body of the vehicle such that the aerodynamic element is deployable between a stowed position, such as that shown in FIG. 1, in which the frame of the aerodynamic element has a first shape and a deployed position, such as that shown in FIG. 2, in which the frame of the aerodynamic element has a second shape that is different than the first shape.

FIG. 2 shows the vehicle of FIG. 1 with the aerodynamic element in a deployed position. As shown in FIG. 2, first side portion 125, second side portion 130 and central portion 135 may each have a different shape than when aerodynamic element 120 is in the stowed position.

In some embodiments, the sheeting may be at least partially transparent. In such embodiments, an exterior lighting element of the vehicle may be visible through the sheeting. For example, as illustrated in FIG. 2, a third brake light 205 may be visible through aerodynamic element 120. This may be beneficial since, in the deployed position, aerodynamic element 120 may otherwise obscure third brake light 205.

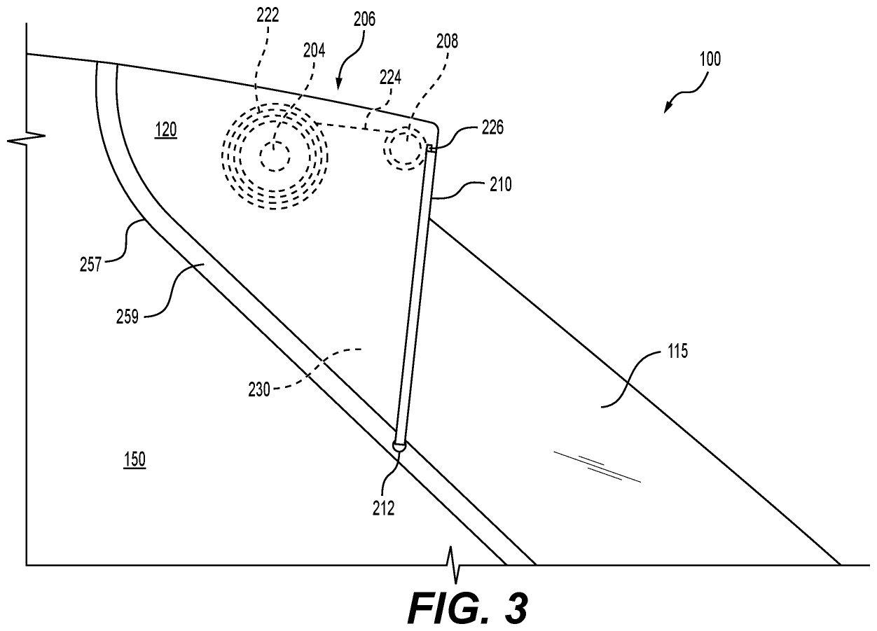

FIG. 3 is a schematic partial side view of a vehicle with an aerodynamic element in a stowed position according to an exemplary embodiment.

In some embodiments, the frame of the aerodynamic element may be pivotally attached to the vehicle body. For example, the frame may be rotated about a point of rotation in order to elongate a portion of the sheeting at an end opposite the point of rotation. As shown in FIG. 3, aerodynamic element 120 may have a point of rotation 212 about which a peripheral frame 210 may be rotated.

As shown in FIG. 3, Aerodynamic element 120 may be affixed to C-pillar 150 at an interface 257 defined by a window trim 259 that at least partially surrounds rear window 115. As also shown in FIG. 3, the sheeting portion of aerodynamic element 120 may be dispensed from a reel in order to extend the sheeting surface when peripheral frame 210 is moved away from the body of vehicle 100. For example, a reel dispensing system 206 may include a reel 204 may contain a roll 222 of sheeting material. As further shown in FIG. 3, a dispensed portion 224 of sheeting material attaches to peripheral frame 210 at a connection point 226 on a second reel 208.

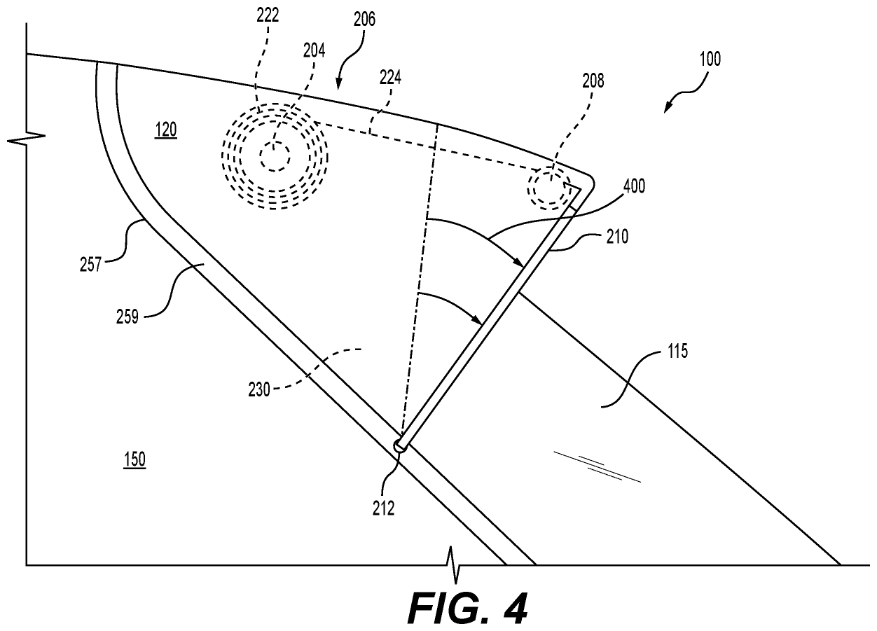

FIG. 4 shows the vehicle of FIG. 3 with the aerodynamic element in a deployed position. Arrows 400 illustrate the motion of deployment of the aerodynamic element, which occurs by virtue of the rotation of peripheral frame 210 about point of rotation 212. As shown in FIG. 4, the amount of dispensed sheeting 224 forming the surface of aerodynamic element 120 is greater than in the stowed position shown in FIG. 3.

It will be understood that the sheeting may be formed of any sheeting material suitable for the exterior of a vehicle. The sheeting may be formed of any suitable flexible material, such as fabric, rubber, non-Newtonian fluid, etc.

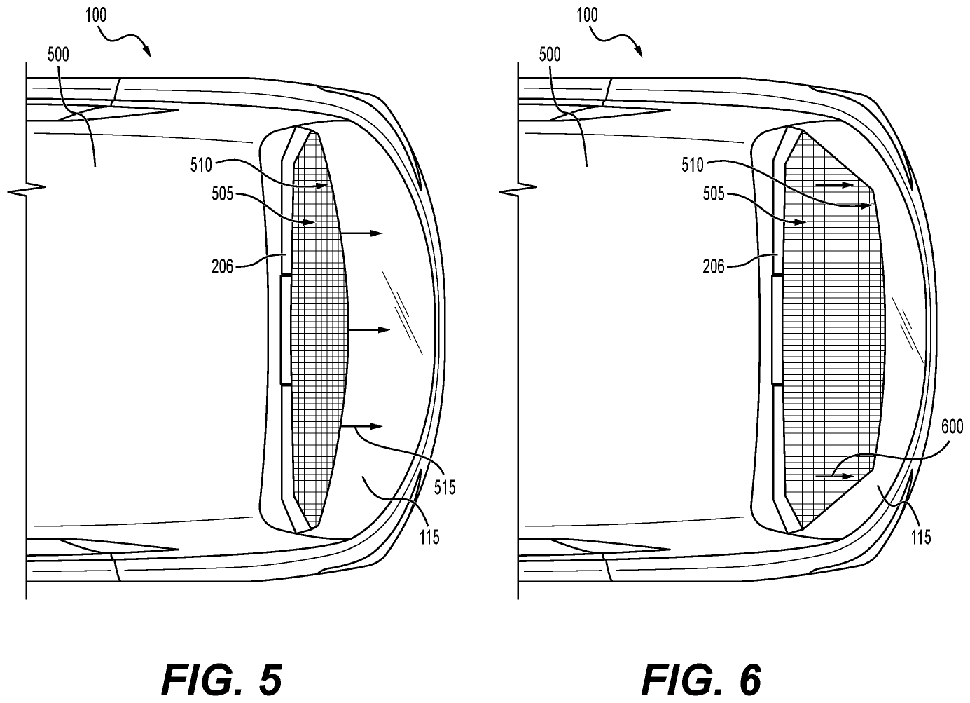

FIGS. 5 and 6 illustrate the difference in shape of the aerodynamic element due to the difference in shape of the frame members. In particular, the side portions of the frame become elongated, and the center portion goes from mostly curved, to only partially curved.

FIG. 5 is a schematic partial top view of a vehicle with an aerodynamic element in a stowed position according to an exemplary embodiment. As shown in FIG. 5, a vehicle roof 500 includes aerodynamic element 120 at the rear portion, in this case at a top portion of the rear hatch. Aerodynamic element 120 is formed of peripheral frame 510 and sheeting 505 extending between the vehicle body and peripheral frame 510. Sheeting reel system 206 is shown in FIG. 5 schematically. When actuated, aerodynamic element 120 may be deployed in the direction of arrows 515.

FIG. 6 shows the vehicle of FIG. 5 with the aerodynamic element in a deployed position. As shown in FIG. 6, the peripheral frame has been moved in the direction of arrows 600 and, as a result, the frame has changed shape.

In some embodiments, at least one structural member of the frame is deformable to have a different length in the deployed position than in the stowed position. Additionally, or alternatively, in some embodiments, at least one structural member of the frame is deformable to have a different curvature in the deployed position than in the stowed position. As shown in FIG. 5, the side portions of aerodynamic element 120 become elongated, and the trailing edge changes curvature.

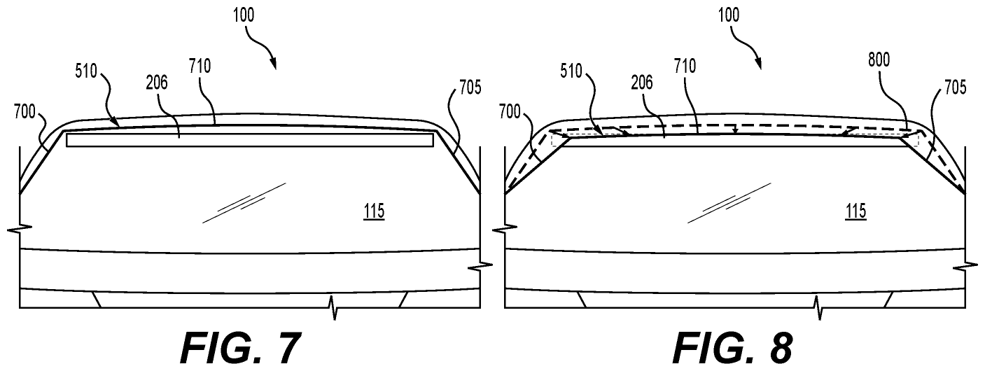

FIG. 7 is a schematic partial rear view of a vehicle with an aerodynamic element in a stowed position with a frame of the aerodynamic element illustrated. As shown in FIG. 7, a first side frame element 700 and a second side frame element 705 are in a first position and have a first length. In addition, a trailing edge frame element 710 has a first curvature.

FIG. 8 shows the vehicle of FIG. 7 with the aerodynamic element in a deployed position. As shown in FIG. 8, first side frame element 700 and second side frame element 705 have a different length. In addition, trailing edge frame element 710 has a different curvature. Overall, the difference in frame shapes gives the aerodynamic element a more hooded shape curving around rear window 115. This may reduce drag and/or provide other aerodynamic benefits.

The aerodynamic elements discussed herein may be implemented as part of a system controllable automatically and/or with user input. Accordingly, the system may include not only the aerodynamic element, but also a controller configured to receive conditions data and an actuator for controlling deployment of the aerodynamic device.

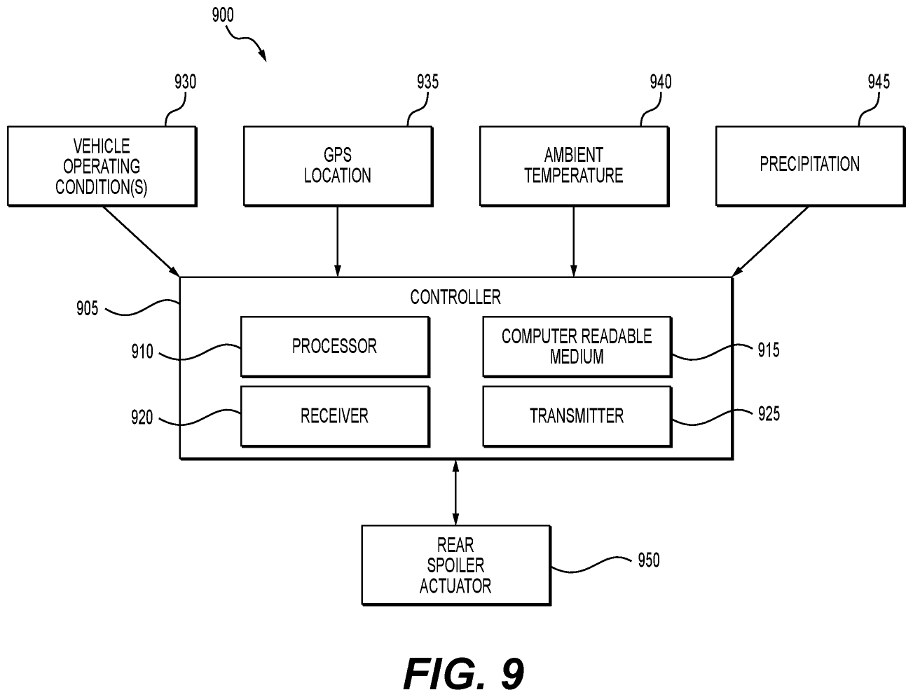

FIG. 9 is a schematic block diagram illustrating components of an adaptive aerodynamic system. As shown in FIG. 9, an adaptive vehicle aerodynamics system 900 includes a controller 905. Controller 905 may include various computing and communications hardware, such as servers, circuitry, displays, etc. Further, controller 905 includes a device processor 910 and a non-transitory computer readable medium 915 including instructions executable by device processor 910 to perform the processes discussed herein, such as controlling operation of the deployable aerodynamic element.

The non-transitory computer readable medium may include any suitable computer readable medium, such as a memory, e.g., RAM, ROM, flash memory, or any other type of memory known in the art. In some embodiments, the non-transitory computer readable medium may include, for example, an electronic storage device, a magnetic storage device, an optical storage device, an electromagnetic storage device, a semiconductor storage device, or any suitable combination of such devices. More specific examples of the non-transitory computer readable medium may include a portable computer diskette, a floppy disk, a hard disk, a read-only memory (ROM), a random access memory (RAM), a static random access memory (SRAM), a portable compact disc read-only memory (CD-ROM), an erasable programmable read-only memory (EPROM or Flash memory), a digital versatile disk (DVD), a memory stick, and any suitable combination of these exemplary media. A non-transitory computer readable medium, as used herein, is not to be construed as being transitory signals, such as radio waves or other freely propagating electromagnetic waves, electromagnetic waves propagating through a waveguide or other transmission media (e.g., light pulses passing through a fiber-optic cable), or electrical signals transmitted through a wire.

Instructions stored on the non-transitory computer readable medium for carrying out operations of the present invention may be instruction-set-architecture (ISA) instructions, assembler instructions, machine instructions, machine dependent instructions, microcode, firmware instructions, configuration data for integrated circuitry, state-setting data, or source code or object code written in any of one or more programming languages, including an object oriented programming language such as Smalltalk, C++, or suitable language, and procedural programming languages, such as the “C” programming language or similar programming languages.

Aspects of the present disclosure are described in association with figures illustrating flowcharts and/or block diagrams of methods, apparatus (systems), and computing products. It will be understood that each block of the flowcharts and/or block diagrams can be implemented by computer readable instructions. The flowcharts and block diagrams in the figures illustrate the architecture, functionality, and operation of possible implementations of various disclosed embodiments. Accordingly, each block in the flowchart or block diagrams may represent a module, segment, or portion of instructions. In some implementations, the functions set forth in the figures and claims may occur in an alternative order than listed and/or illustrated.

Controller 905 may include networking hardware configured to interface with other nodes of a network, such as a LAN, WLAN, or other networks. In Further, controller 905 may be configured to receive data from a plurality of sources and communicate information to one or more external destinations. Accordingly, controller 905 may include a receiver 920 and a transmitter 925. (It will be appreciated that, in some embodiments, the receiver and transmitter may be combined in a transceiver.)

Any suitable communication platforms and/or protocols may be utilized for communication between controller 905 and other components of the system. Since the various sources of information may each have their own platform and/or protocol, the system may be configured to interface with each platform and/or protocol to receive the data.

In some embodiments, computer readable medium 915 of controller 905 includes instructions, executable by processor 910, to receive data from one or more sources and control the deployable aerodynamic element based on the conditions indicated by the received data. For example, in some embodiments, computer readable medium 915 includes instructions for receiving data regarding vehicle operating conditions (930). Such vehicle operating conditions may include, for example, vehicle speed, acceleration, yaw rate, etc. In addition, another vehicle condition that may be detected is a manual selection to deploy or stow the aerodynamic element.

Alternatively, or additionally, controller 905 may be configured to receive data regarding the Global Positioning System (GPS) location (935) of the vehicle. Controller 905 may also be configured to receive data regarding ambient temperature (940) and/or precipitation (945). It will be understood that controller 905 may be configured (via instructions in computer readable medium 915) to receive data regarding various other vehicular and/or environmental conditions.

System 900 may also include a deployable aerodynamic element, such as a rear spoiler. The aerodynamic element may include a deformable frame forming at least a portion of a periphery of the aerodynamic element, and sheeting configured to extend between the frame and a body of the vehicle, wherein the frame is movable with respect to the body of the vehicle such that the aerodynamic element is deployable between a stowed position in which the frame of the aerodynamic element has a first shape and a deployed position in which the frame of the aerodynamic element has a second shape that is different than the first shape.

As illustrated by the double-headed arrow in FIG. 9, controller 905 may be configured to send instructions to, and receive data from, a rear spoiler actuator (950). For example, not only may controller 905 send instructions to deploy and stow the spoiler, but the position of the spoiler may be detected by the system and received by controller 905. Further, the system may determine whether a deploy/stow instruction needs to be sent based on the current position of the spoiler detected by the system.

In some embodiments, computer readable medium 915 may include instructions for automated control of the deployable aerodynamic element. For example, the system may be configured to automatically deploy/stow the spoiler based on the data received by the controller.

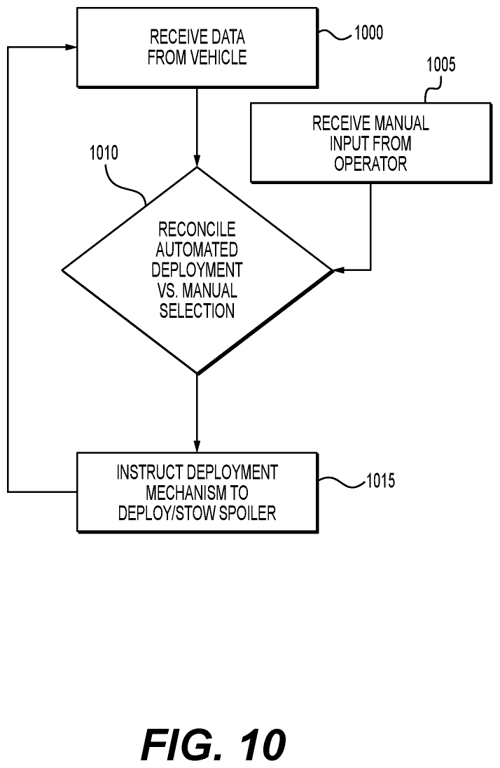

FIG. 10 is a flow chart illustrating steps of a method of operating the system illustrated in FIG. 9. As shown in FIG. 10, at step 1000, the controller may receive data from the vehicle. This data may include not only vehicle operations data (e.g., vehicle speed, acceleration, etc.), but also environmental data (e.g., ambient temperature, precipitation, altitude, etc.).

In addition, at step 1005, the controller may receive manual input from an operator of the vehicle. At step 1010, the system may determine whether or not the aerodynamic element should be deployed and reconcile the automated deployment versus the manual selection of the operator. For example, in some embodiments, the computer readable medium may include instructions for receiving input from an operator and overriding automated control of deployment of the aerodynamic element based on the input from the operator.

Once a determination has been made whether to deploy or stow the aerodynamic element at step 1010, the system may, at step 1015, instruct the deployment mechanism to deploy or stow the spoiler accordingly.

The aerodynamic element may be either stowed or deployed as the default. For example, in some embodiments, the computer readable medium includes instructions for maintaining the aerodynamic element in the stowed position as a default position. Alternatively, in other embodiments, the computer readable medium includes instructions for maintaining the aerodynamic element in the deployed position as a default position.

As shown in FIG. 10, the method logic may loop back to the beginning, with controller constantly evaluating vehicle operating conditions, environmental conditions, and operator input to determine whether to deploy or stow the aerodynamic element.

While various embodiments have been described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with, or substituted for, any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

1. A deployable aerodynamic element for a vehicle, comprising:
a deformable frame forming at least a portion of a periphery of the aerodynamic element; and
sheeting configured to extend between the frame and a body of the vehicle;
wherein the aerodynamic element is deployable between a stowed position in which the frame of the aerodynamic element has a first shape and a deployed position in which the sheeting of the aerodynamic element has a second shape that is different than the first shape.

2. The aerodynamic element of claim 1, wherein at least one structural member of the frame is deformable to have a different curvature in the deployed position than in the stowed position.

3. The aerodynamic element of claim 1, wherein at least one structural member of the frame is deformable to have a different length in the deployed position than in the stowed position.

4. The aerodynamic element of claim 1, wherein the aerodynamic element is configured for use as one of the following vehicle components:
a roof spoiler;
a front air dam;
wheel strakes;
an underbody cover;
a sunroof wind deflector;
a decklid spoiler;
a side window visor; and
a hood deflector.

5. The aerodynamic element of claim 1, wherein the sheeting material is at least partially transparent.

6. An adaptive vehicle aerodynamics system, comprising:
a deployable aerodynamic element, including:
a deformable frame forming at least a portion of a periphery of the aerodynamic element; and
sheeting configured to extend between the frame and a body of the vehicle;
wherein the frame is movable with respect to the body of the vehicle such that the aerodynamic element is deployable between a stowed position in which the frame of the aerodynamic element has a first shape and a deployed position in which the frame of the aerodynamic element has a second shape that is different than the first shape; and
a controller including a device processor and a non-transitory computer readable medium including instructions executable by the processor to control operation of the deployable aerodynamic element.

7. The system of claim 6, wherein the computer readable medium includes instructions for automated control of the deployable aerodynamic element.

8. The system of claim 7, wherein the computer readable medium includes instructions for maintaining the aerodynamic element in the stowed position as a default position.

9. The system of claim 7, wherein the computer readable medium includes instructions for maintaining the aerodynamic element in the deployed position as a default position.

10. The system of claim 7, wherein the computer readable medium includes instructions for receiving input from an operator and overriding automated control of deployment of the aerodynamic element based on the input from the operator.

11. The system of claim 6, wherein the aerodynamic element is configured for use as one of the following vehicle components:
a roof spoiler;
a front air dam;
wheel strakes;
an underbody cover;
a sunroof wind deflector;
a decklid spoiler;
a side window visor; and
a hood deflector.

12. The system of claim 6, wherein at least one structural member of the frame is deformable to have a different curvature in the deployed position than in the stowed position.

13. The system of claim 6, wherein at least one structural member of the frame is deformable to have a different length in the deployed position than in the stowed position.

14. The system of claim 6, wherein the sheeting material is at least partially transparent.

15. A vehicle having an adaptive aerodynamic element, comprising:
a vehicle body; and
a deployable aerodynamic element mounted on the vehicle, the deployable aerodynamic element including:
a deformable frame forming at least a portion of a periphery of the aerodynamic element; and
sheeting configured to extend between the frame and the vehicle body;
wherein the frame is movable with respect to the vehicle body such that the aerodynamic element is deployable between a stowed position in which the frame of the aerodynamic element has a first shape and a deployed position in which the frame of the aerodynamic element has a second shape that is different than the first shape.

16. The vehicle of claim 15, wherein the aerodynamic element is configured as one of the following components of the vehicle:
a roof spoiler;
a front air dam;
wheel strakes;
an underbody cover;
a sunroof wind deflector;
a decklid spoiler;
a side window visor; and
a hood deflector.

17. The vehicle of claim 15, wherein at least one structural member of the frame is deformable to have a different curvature in the deployed position than in the stowed position.

18. The vehicle of claim 15, wherein at least one structural member of the frame is deformable to have a different length in the deployed position than in the stowed position.

19. The vehicle of claim 16, wherein the frame is pivotally attached to the vehicle body.

20. The vehicle of claim 16, wherein the sheeting is at least partially transparent; and
wherein an exterior lighting element of the vehicle is visible through the sheeting.
